(19) United States
(12) Patent Application Publication
(10) Pub. No.: US 2020/0341855 A1
(43) Pub. Date: Oct. 29, 2020

(54) OBJECT STORE SPECIALIZED BACKUP AND POINT-IN-TIME RECOVERY ARCHITECTURE

(71) Applicant: Ashish Tanwer,, Sunnyvale, CA (US)

(72) Inventors: Ashish Tanwer, Sunnyvale, CA (US); Kevin Kingdon, Eagle Mountain, UT (US); Nadeem A Nazeer, Lehi, UT (US)

(73) Assignee: Synamedia, Staines, Mx (GB)

(21) Appl. No.: 16/396,698

(22) Filed: Apr. 28, 2019

(51) Int. Cl. G06F 11/14; H04L 29/08; H04L 29/06

(52) U.S. Cl. CPC G06F 11/1451; G06F 2201/80; H04L 65/4092; H04L 67/1097

(57) ABSTRACT

The innovation is the design an efficient and precise object storage backup, versioning, and point-in-time recovery solution designed for distributed storage with complex architecture like splitting data cluster from metadata cluster and running hundreds of optimization services constantly moving data. The solution works on the principle of periodically snapshotting the object storage data and metadata nodes on to a backup medium. It further adds the architecture of centralized or distributed transaction recording. The patent covers the implementation details of backup and recovery solution for OpenStack Swift, a popular free and open-source object storage system as an example and can be tweaked to work with most architecturally similar storage solutions. The innovation allows reducing CPU and diskspace requirements, backup and recovery latency and minimizing the bandwidth consumption during backup. It allows fine-grain point-in-time recovery with fast convergence by removing the need to duplicate computing work already done before the crash. The solution is designed to address backup node cost concerns, backup space cost concerns and operation time concerns. The solution has high availability, reliability, and fidelity to continuous back with little running overhead and safely and efficiently recover data during a crash.

### REFERENCE CITED

### U.S. Patent Documents

| | | |
|---|---|---|
| Nov. 30, 2006 | US20060271604A1 | Shoens, Kurt |
| Jun. 28, 2012 | US20120166394A1 | KIM, Mi-Jeom; Park, Chang- |
| | | Sik; Lee, Eo-hyung; |
| Aug. 8, 2013 | US20130204849A1 | Chacko, Peter |
| Feb. 20, 2014 | US20140052700A1 | VanderSpek, Adrian; Poirier, |
| | | Jamey C.; Makosky, Lucas H.; |
| Jul. 31, 2014 | US20140215057A1 | Walsh, Alexander Leonard; |
| | | Spraggins, Daniel Joseph |
| Feb. 16, 2010 | U.S. Pat. No. 7,664,771B2 | Kusters, Norbert P.; Leis, |
| | | Benjamin A.; Zbikowski, Mark J. |
| Jan. 29, 2013 | U.S. Pat. No. 8,364,648B1 | Sim-Tang, Siew Yong |
| Jul. 29, 2014 | U.S. Pat. No. 8,793,343B1 | III, James Christopher |
| | | Sorenson; Lin, Yun |
| Feb. 7, 2017 | U.S. Pat. No. 9,563,517B1 | Natanzon, Assaf; WEISS, Eran |
| Oct. 16, 2008 | US20080256138A1 | Sim-Tang, Siew Yong |
| Jun. 28, 2012 | US20120166403A1 | KIM, Mi-Jeom; Kim, Hyo-Min; |
| | | Lee, Eo-hyung; Hwang, Jin-Kyung |
| Oct. 10, 2013 | US20130268740A1 | Holt, Gregory |
| Feb. 27, 2014 | US20140059551A1 | Umanesan, Ganesan |
| Sep. 18, 2014 | US20140280433A1 | Messerli, Antony; Voccio, Paul |
| Mar. 30, 2010 | U.S. Pat. No. 7,689,602B1 | Sim-Tang, Siew Yong |
| Mar. 19, 2013 | U.S. Pat. No. 8,401,997B1 | Tawri, Deepak; Karr, Ronald |
| | | S.; Colgrove, John A.; |
| Sep. 2, 2014 | U.S. Pat. No. 8,826,279B1 | Pacheco, David; Cavage, Mark; |
| | | Xiao, Yunong; Cantrill, Bryan |
| Oct. 28, 2010 | US20100274765A1 | Murphy, Elissa E. S.; Virk, |
| | | Navjot |
| Sep. 13, 2012 | US20120233134A1 | Barton, Michael; Reese, Will; |
| | | Dickinson, John A.; Payne, Jay B.; |
| Oct. 31, 2013 | US20130290361A1 | Anderson, Eric A.; Wylie, |
| | | John Johnson; Tucek, Joseph A. |
| Mar. 13, 2014 | US20140075557A1 | Balabine, Igor; Velednitsky, |
| | | Alexander |
| Jun. 28, 1994 | U.S. Pat. No. 5,325,528A | Klein, Johannes |
| Sep. 14, 2010 | U.S. Pat. No. 7,797,283B2 | Fachan, Neal T.; Passey, |
| | | Aaron J.; Schack, Darren P. |
| Jun. 25, 2013 | U.S. Pat. No. 8,473,526B2 | Zlotnick, Aviad |
| Aug. 18, 2015 | U.S. Pat. No. 9,110,965B1 | Shah, Kushal; Chatur, |
| | | Makarand; Deshmukh, Manav; |
| Apr. 14, 2011 | US20110087792A2 | Wayda, James; Rodriguez, |
| | | Elizabeth; Lee, Kent |
| Sep. 13, 2012 | US20120233522A1 | Barton, Michael; Reese, Will; |
| | | Dickinson, John A.; Payne, Jay B.; |
| Nov. 21, 2013 | US20130311612A1 | Dickinson, John A. |
| Apr. 17, 2014 | US20140108474A1 | David, Goetz; Holt, Gregory |
| | | Lee |
| Jul. 26, 1994 | U.S. Pat. No. 5,333,314A | Masai, Kazuo; Wakayama, |
| | | Satoshi; Yamamoto, Shoji; |
| Sep. 6, 2011 | U.S. Pat. No. 8,015,211B2 | Marceau, Carla; Stillerman, |
| | | Matthew A. |
| Dec. 31, 2013 | U.S. Pat. No. 8,620,879B2 | Cairns, Ryan |
| Apr. 26, 2012 | US20120102291A1 | Cherian, Jacob; Chawla, |
| | | Gaurav |
| Feb. 14, 2013 | US20130041872A1 | AIZMAN, Alexander; Bestler, |
| | | Caitlin |
| Dec. 5, 2013 | US20130325950A1 | Laden, Guy; Melamed, Roie |
| May 29, 2014 | US20140149794A1 | Shetty, Sachin; Sankar, |
| | | Krishna; Jassal, Amrit; Patel, Kalpesh; |
| May 13, 1997 | U.S. Pat. No. 5,630,047A | Wang, Yi-Min |
| Jan. 31, 2012 | U.S. Pat. No. 8,108,429B2 | Sim-Tang, Siew Yong; Fraisl, |
| | | Daniel J. |
| Jan. 7, 2014 | U.S. Pat. No. 8,626,793B2 | Cameron, Donald F.; |
| | | Strickland, Dancil C. |
| Mar. 29, 2016 | U.S. Pat. No. 9,298,723B1 | Vincent, Pradeep |
| May 10, 2012 | US20120117320A1 | Pinchover, Yishai Baruch; |
| | | Mandel, Ron |
| Jul. 18, 2013 | US20130185258A1 | Bestler, Caitlin; AIZMAN, |
| | | Alexander |
| Feb. 6, 2014 | US20140040197A1 | Wijayaratne, Ravi; Koos, |
| | | Remus; White, Ray; Marathe, Manish; |
| Jul. 31, 2014 | US20140214915A1 | Dragon, Monsyne Michael; |
| | | Walsh, Alexander Leonard; |
| Apr. 18, 2000 | U.S. Pat. No. 6,052,695A | Abe, Kenichi; Imafuku, |
| | | Yukiharu; Kirita, Hitoshi; |
| Jan. 8, 2013 | U.S. Pat. No. 8,352,941B1 | Protopopov, Boris; Leschner, |
| | | Jurgen |
| Sep. 27, 2016 | U.S. Pat. No. 9,454,318B2 | Zhu, Ming Benjamin; |
| | | Patterson, R. Hugo; Li, Kai |

### BACKGROUND

With the upsurge of computing devices like workstations, laptops, mobile and smart devices, and evolution of “internet of things”, the amount of data generated is increasing exponentially and the storage requirements are skyrocketing. On the one hand, there are technical limitations to increase the storage per unit, to increase storage units per device, to perform read, write or updates in a timely manner as the storage per device increases, and to reliably store and recover data in case of device failure. On the other hand, data communication rates, whether on local area network or internet are increasing at a fast pace. As the vertical scaling of storage is not economically feasible and possible after some limits, horizontal scaling is the only solution. The situations are ideal for the rise of the distributed object storage systems for Cloud Storage and Big Data technologies are becoming more prominent. With the advancement of distributed object storage systems, there is a need to develop and improve complementary distributed backup and recovery solution architecture. Network speed related enhancements have enabled to backup or revert from a different a LAN, WAN, or internet site.

Current Backup and Recovery solutions allow Backup to one or more new devices and recovering from them. With the large volume of data in the distributed object storage, the current methods will not be scalable. A new network or cloud backup system is required to backup and restore from a distributed object storage system. It will be more cost-effective, reliable, resilient to disk or device crash, scalable and almost as fast as a traditional local backup. However, the tradeoff is the high network bandwidth requirement to backup each version or snapshot or the data.

The distributed object storage systems and the Big data storage systems are designed to be fault tolerant and resilient to the system nodes and network failures. Current, distributed storage systems maintain N replicas of same data where N is the called replication factor for the cluster. Maintaining multiple replicas allow recovery when a few devices or nodes crash depending on the replication factor. Most distributed storage systems are eventually consistent or on the AP side in CAP theory. This allows such systems to recover when a data-center is down or during a network outage or partition without much efforts. But not much attention was given to design a distributed storage system that inherently has an optimized network or cloud-based backup solution and point-in-recovery solution to revert to a previous version in case of an unavoidable situation. In most systems, when there are more nodes crashed than the replication factor of the cluster, the data loss is imminent. Data in such systems can also get altered and tempered during cyber and hacking attacks. So, despite most distributed Object Storage being very resilient in nature, there is an inherent need for a distributed backup and recovery solution for fault tolerance. Distributed point-in recovery will provide a guarantee of recovery in case of complete system failures like hacking, attacks, and the mistakes by application layer and by users/apps.

The prevalent distributed backup and recovery solutions are very primitive in nature. They allow reverting back to point where the backup was taken and there is no way to revert back to the desired point in time. A partial backup functionality can be achieved with versioned objects or snapshotting. But the recovery in the case of versioned objects has large storage implications and snapshotting is limited to recovery of snapshots and loss of data between snapshots. A partial point-in recovery functionality for mutations can be achieved by sending delete traffic corresponding to the mutation traffic but the most distributed Object Storages do not have a precise accounting of the input traffic. There is no way to do point-in recovery for delete traffic and contents are lost forever. The application layer generally takes care of making sure the traffic is correct. Sometime the application layer may provide some recovery functionality by delay delete traffic. As there is no internal architecture and mechanisms to the basic functionalities, most of such systems are very slow and network bandwidth extensive and require a lot of computing resources.

The design of distributed backup and recovery solutions has some fundamental problems to overcome. Most distributed Object Storages are in a constant state of flux of data where replicas constantly change location depending on storage load and available storage space. When the load is low some nodes are switched off and when the load is high more nodes are added. Merely, snapshotting and taking the backup of each node and revert it backup for recovery can give system in the completely different state. All these movements of replicas and optimizations need to be redone that takes significant computing resources and redoing all work is not only very extensive but also sometimes not possible which can lead to the unrecoverable or broken system.

The various algorithms decide the location of the data like number and arrangement of the data nodes (datacenters, clusters, PODs), number, arrangement and Redundant Array of Inexpensive Disks (RAID) type of the disks, disk capacity and failures avoidance, block replication factory of data, storage load balancing. Various algorithms work to load balance between data centers in a cluster. Algorithms try to keep different data on different disks on a node and on different disk partition for better data recovery in case of a crash. Also, algorithms try to balance storage node between high storage capacity nodes and low storage capacity nodes so that no node gets completely filled. In the case of node failures, the data is shifted to other nodes in a proportional manner and moves back when the node comes back online, or a new data node is added.

The design considers it is not possible to support a maintain a separate duplicated Data Center in the cluster with all nodes mirrored, due to high hardware cost and maintenance cost. The presented design utilizes minimum additional hardware resources (disks, nodes), adding minimum latency to the traffic and the shortest and fastest path to the desired point-in-time recovery wasting minimalistic computing resources.

The primary reason for the same is clouds is considered safer and operate even when some parts of the cloud are down. The second reason is cloud needs distributed backup solutions, that are very hard to design. These solutions are required to prevent data loss in several adverse cases, like hacking, or DDOS attacks or the cases where input traffic is flawed or compromised.

Most solutions available in the market are very primitive and are specialized for cloud implementation. There are fundamental problems with current solutions

1 The backup diskspace: For distributed backup, every node in the system is required to be snapshotted and copied. It required a large amount of data to be generated copies, managed, and storage for each backup.
2 The recovery time: The recovery time is too high due to large volumes of data and too much bandwidth requirements. Also, for the individual nodes, convergence time after recovery is high.
3 The recovery precision: The cloud is only recovered to the last backup point and point close. But they cannot be precisely recovered to any point in time of interest.
4 Specialized Implementations: There are a variety of solutions developed speciated for every cloud type. There is no fit-all type solution available in the market.

Mainly, there are 2 types of distributed backup and recovery solutions available in the market.

The type A solutions rely on the cloning the cloud cluster in a second data center (DC) and then periodically syncing with the primary data center. These types of solution need twice the number of nodes, both computing and storage resources identical to the primary data center. These solutions provide low recovery time after the crash and moderate recovery precision, at the trade-off of duplicating every node and resource like network and operation and thus doubling the cloud management cost. For clouds where the economy is concerned, the type A solutions are impractical due to very high cost. The type A solutions are used in subscription Clouds like Amazon Web Services (AWS) and Google Cloud Platform (GCP).

The type B solutions rely on the snapshotting every node and saving them on the remote cloud cluster. The solution requires complete all nodes backups again and again. Without computing resource, old backups cannot sync with the new backups like in the type A solutions. These solutions provide a low-cost operation cost then of the type A solutions and do not need every node to be duplicated like in the type A solutions. The type B solutions need big volume backup diskspace and high network bandwidth. The recovery time is high and recovery precision is low. The backup and recovery solution in OpsCenter manager for Cassandra is the type B solution.

There are numerous end-devices backup and recovery solutions available in the market. But there is a scarcity of solutions designed for distributed object storage. There is no distributed storage backup and recovery solution in the market that can simultaneously address node cost concerns, backup space concerns with operation time concerns in spite of their very identical design.

### SUMMARY

The contrary of the commonly available systems, current innovation is a completely new design that allows reducing latency and bandwidth consumption during backup and allows fine-grain point-in-time recovery with fast convergence by removing the need to duplicate computing work already done before the crash. It provides a mechanism to significantly reduce bandwidth requirements. It has a modular architecture and has a clean division between Object Storage dependent modules and generic modules. The solution enables to recover to any point-in-time point granularly, not just the snapshotted versions without the computing overheads for moving and optimizing the data. The current innovation is a modified version of Type B solutions that handle all concerns. It can also help to prevent data loss in several adverse cases, like hacking, or cyber-attacks like DDOS or the cases where input traffic is flawed or compromised.

The patent covers the implementation details of OpenStack Swift Object Storage. The drawings below explain the process of backup and recovery using the solution. Some components mention here by the same name, vary in functionality with cloud implementation change. Also, the workflow of the solution varies a bit with the platform implementation. Further details are provided in the patent document. The current innovation is an enterprise-ready cloud backup and recovery solution that solves the high computing resource requirements, high storage requirements, high network bandwidth requirements, and very high recovery time. The solution is designed to be economical for computing, network, and storage resources while offering faster and precise point-in-time recovery. The solution is a very low operating cost performance impact. The system is 300% to 500% times cheaper than existing solutions due to the removal of all extra replicas.

The recovery precision is due to continuous transaction recording and not continuous journaling of the actual data of disks. Except for some highly optimized Object Storage implementations, continuous journaling is not always a good solution. It takes a large amount of CPU resource and introduces latency. On the other hand, recovery precision due to the continuous transaction recording does not add any latency. The solution works principle of the periodic snapshotting of the data nodes. The Time-to-Live (TTL) value of data in the transaction cluster 201, is maintained more than the snapshotting internal of the data to successfully recover the data.

All these algorithms vary in cloud implementations and requirements. These algorithms take a significant amount of computing. My algorithm saves this compute work done by various services as transaction logs. Also, these transaction logs are periodically sent to the Transaction Cluster 201 where these logs are merged vectorially with the existing recorded transaction. As a result, during recovery when the data is sent back to the nodes, all the work done before the crash is need not to be redone.

The innovation is the design is an efficient and generic network-based distributed storage or cloud backup, versioning, and point-in-time recover solution. The solution works on the principle of periodically snapshotting the distributed system or cloud on a backup medium and the centralized transaction recording. It provides a very low operating cost and a very low impact on the performance of the system.

### Problem Solved

1 The backup diskspace: The solution introduces a “de-replicator” service that can reduce the backup data amount by the replication factor. There is a “data deduplicator 205” module for in-process client-side deduplication to further decrease the size of full and incremental snapshots. The system is designed to be capable of 300% to 500% reduction in storage space.
2 The recovery time: The solution described in the innovation, finds the shortest path of recovery through the Transaction Cluster. “Transaction Compactor” and “Transaction Collection” components are constantly optimizing and reducing the path of recovery. The solution combines external Transactions (mutations) from the application with the Transactions generated from the journaling the internal services to remove the need for duplicated work to be done after recovery saving a lot of computing on each node and extremely fast recovery time.
3 The recovery precision: The solution has a Transaction Player component that transforms the transaction back to request from. All the recorded transactions are timestamped and played/streamed in the timestamp order that allows precision in recovery and tolerance to any misconfiguration.
4 Specialized Implementations: The solution is modular in nature and most components are generic in nature making it compatible with a variety of cloud implementations. There are details on how to effectively implement cloud-specific platform-dependent modules. It always has a platform dependent module called Snapshotting and Cloning Module 203 (SCM) and patent covers sufficient details of its implementation SCM on various popular cloud Platforms.

### BRIEF DESCRIPTION OF DRAWINGS

FIG. 1: The basic architecture of the distributed object storage

FIG. 2: The backup architecture of the distributed object storage

FIG. 3: The recovery architecture of the distributed object storage

FIG. 4: The backup process of the distributed object storage

FIG. 5: The recovery process of the distributed object storage

### DETAILED DESCRIPTION

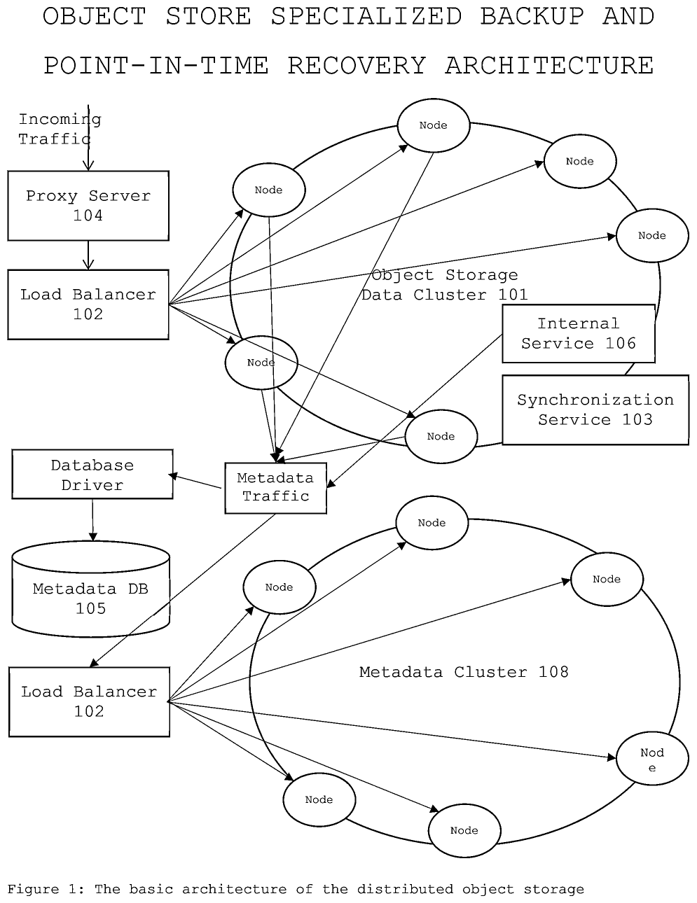

In object storage, data is exposed and managed as objects instead of files or blocks. Objects contain properties which can be used for better indexing or management. Object storage allows the addressing and identification of individual objects by more than just file name and file path. Object storage adds a unique identifier within a bucket, or across the entire system, to support much larger namespaces and eliminate name collisions. Object storage explicitly separates file metadata from data to support additional capabilities like better indexing, better data-management policies, centralize management of storage and optimize metadata storage. Some object storage implementations supporting functionality like object versioning, object replication, and movement of objects between different tiers and types of storage. Most API implementations are RESTful, allowing the use of many standard Hypertext Transfer Protocol (HTTP) calls. Some examples of object storage are Dell EMC Elastic Cloud Storage, EMC Centera, EMC Atmos, Hitachi Content Platform (HCP), Cisco COS (Cloud Object Storage), IBM Cleversafe, IBM Spectrum Scale (GPFS), NetApp Storage GRID, Redhat GlusterFS, cloud services vendors like Amazon AWS S3, Microsoft Azure and Google Cloud Storage, or open-source object storage like Lustre, OpenStack Swift, and Ceph. FIG. 1 describes the basic Architecture of Distributed Object Storage

The data cluster 101 is a primary cluster that stores all the data and needs to be backup for disaster recovery. It consists of a set of data nodes each containing some computing resource, storage to store a part of the data of cluster and networking resources to communicate with other data nodes. The node storage consists of a set of hard disks HDDs, Solid-state drive (SSDs) configured in hardware or software Redundant Array of Inexpensive Disks (RAID) or “just a bunch of disks” (JBOD). The data storage object storage can be snapshotting object storage or non-snapshotting object storage.

Most distributed object storage implementations need to store the metadata information in a separate metadata database 105 or metadata cluster 108 decoupled from the data cluster 101. It typically stores the data allocation and additional metadata information for bookkeeping and application use. It acts as the brain of such a storage system. It needs to be high performance and low latency system as it is used for each and every lookup or query. In metadata cluster 108 implementation, it is similar to the data cluster 101 in architecture and the data node structure, but it is comparatively far smaller and far more performing than the data cluster 101. In metadata database 105 implementation, it is typically is a high performance distributed database with no single point of failure.

The load balancer 102 is an essential part of distributed systems. All the mutation and non-mutation traffic go through it and it distributes the traffic load among the data cluster 101 nodes. In one embodiment, the RESTful proxy server 104, the transaction recorder, or the load balancer 102 can be in a single unit or multiple units. NGINX is a very popular, high-performance load balancer 102, web server, & reverse proxy solution. It accelerates content and application delivery, improves security, facilitates availability and scalability for the busiest websites on the Internet. It also provides module ngx http mirror module that implements mirroring of an original request by creating background mirror subrequests can be used for traffic recording as well. HAProxy, or High Availability Proxy, is another popular open source Transmission Control Protocol (TCP) or Open Systems Interconnection (OSI) Layer 4 load balancer and Hypertext Transfer Protocol (HTTP) or OSI layer 7 load balancer 102 and proxying solution. It is used to improve the performance and reliability of a server environment by distributing the workload across multiple distributed servers. The Domain Name System (DNS) servers or the name-servers are used to get the address of the machines hosting a resource. Since DNS allows multiple records to be kept (even the same kind), it becomes possible to list multiple hosts as the server for High-Availability (HA) or for the role of layer 7 load balancer 102. Popular DNS servers like Bind provide the basic load-balancing like Round Robin (RR) DNS load-balancing.

There are various services that run-in Data Cluster 101, either on each node or centralized service to control every node. The few important services that generate internal transactions are discussed below:

The metadata compaction or defragmenter service: Most object storage implementations have metadata compaction or defragmenter service that compacts the metadata to reduce the metadata cluster 108 size. It deletes multiple separate entries and make compacted entries and moves or adjusts the corresponding data in the data-cluster.

The data replicator service: Almost all object storage solutions have a data replicator that is responsible for maintaining that data replica count in cluster equal to the Replication Factor (RF) for the cluster. When the replication factor (RF) is increased, or nodes are crashed, it increases the number of replicas in load balancing manner and when the replication factor is decreased, or nodes are added, it gets rids of the extra replicas.

The CPU load balancer service: The object storage systems need a CPU processing load balancer services, that activates when a node is CPU overloaded or oversubscribed or overheated. For example, if a node in the cluster is using more than 90% CPU processing, and it can activate and transfer node independent processing tasks to the underloaded or undersubscribed node.

The diskspace load balancer service: The object storage systems need diskspace load balancer services, that activates when a node is overfull or oversubscribed. For example, if a node's diskspace is 80% full, it can get activated and can move the data and corresponding metadata to undersubscribed nodes or node with free disk space. In the patent, the load balancer service represents both CPU and diskspace load balancing service. Though the backup and recovery process only concern about diskspace load balancer, the CPU balancer still helps in performance improvement.

The ingest optimizer service: Often the object storage systems have service to ingest optimizer that makes multiple copies of the ingest objects more than replication factor to avoid ingest failure. Later, once ingest is complete, it deletes extra replications and corresponding data in the cluster.

All these internal transactions are recorded by all the services or a centralized service and are journaled with a timestamp and sent to the transaction cluster 201.

### Backup Architecture

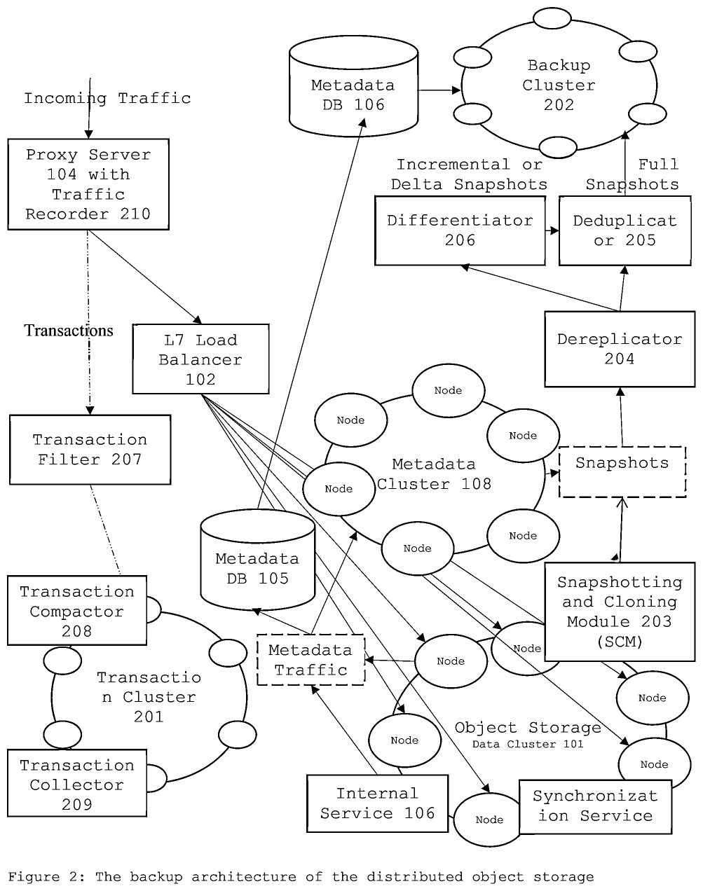

The backup subsystem consists of two addition cluster, the transaction cluster 201 to store the live transactions, and the backup cluster 202 to store then backup snapshots in addition to the data cluster 101 and the metadata cluster 108 or the metadata database 105. All the data nodes and database cluster 108 or the metadata database 105 are in sync with the synchronization service 103. The backup subsystem has components like the traffic recorder 210, the transaction filter 207, and the Snapshotting and Cloning Module 203 (SCM), that are only present on the backup path. Other subsystem components like the data dereplicator 204, the data deduplication 205 and the data differentiator 206 have their counterparts in the recovery subsystem. The transaction cluster 201 has additional components the transaction compactor 208 and the transaction collector 209 for transaction simplification. FIG. 2 describes the backup architecture in the distributed object storage.

In the backup subsystem, the traffic recorder 210 is a component that can perform the real-time recording of the incoming traffic. All the traffic requests are recorded by the traffic recorder 210 with a timestamp and mutated object reference. The traffic can be managed and controlled at the application layer by a RESTful proxy server 104 that can act as the traffic recorder 210. Teeproxy is a layer 7 reverse HTTP proxy that can be used as Transaction Recorder. For each incoming request, it clones the request into 2 requests, forwards them to 2 servers. The result from server A is returned as usual, but the requests to server B can be saved as a transaction in the transaction cluster. Teeproxy handles HTTP GET, POST, and all other HTTP methods. Another good traffic recorder 210 can be duplicator, a TCP proxy that also duplicates traffic to a secondary host. It is an agnostic duplicator and would require one open session per port and is used production systems for making CDN. Twitter's Diffy is a popular tool that acts as a proxy that accepts requests drawn from any source that you provide and multicasts each of those requests to different service instances.

The recorded transactions by the traffic recorder 210 are stored sequentially and then sent to the transaction cluster 201 for storage and optimization by collecting away transaction no longer required and are not in transaction replay period. The transaction cluster 201 is only required during a crash for the recovery. It can be economically designed Cluster or distributed Database solution as performance is not much concern. The transaction cluster 201 contains just the data between the distributed snapshots. For example, consider if the data cluster 101 is consisting of data of last one year of recording on COS, and data nodes are data cluster 101 are snapshotted (avoiding delta vs incremental backup details for simplicity) every 6 hours, then the transaction cluster 201 will just have data of last 6+ hours like 12 hours. In the example, the transaction cluster 201 will have data=12 hours/8760 hours (1 year)= 1/730 or the one 730th amount of data in the data cluster 101 assuming data is coming uniformly. It means for 1000 data nodes; 2 node the transaction cluster 201 is sufficient.

In the backup subsystem, the transaction filter 207 modules are used to separate mutation traffic (write requests, delete requests, and updates requests) from the non-mutation traffic (read requests). It takes input from the traffic recorder 210 and sends Transactions to the transaction cluster. It is essentially a Layer 7 filtering application firewall or Network Appliance. Application Layer traffic can be looked for Request Verb in a context like HTTP GET, POST, PUT or DELETE to filter out mutation traffic. In some embodiments, it is integrated with the Transaction Recorder. It is beneficial to keep it separate as filtering may introduce some latency. For example, 17-filter is a classifier for Linux's Netfilter subsystem which can categorize Internet Protocol packets based on their application layer data.

In the backup subsystem, transaction compactor 208 used to compare data in the transaction cluster 201 and remove redundancy or multiple values of each object. All the recorded transactions by traffic recorder 210 or by other services are in format or schema with essential fields like mutated object reference or id, the timestamp, and mutated object value and some additional metadata information. When an object is deleted, the corresponding transaction has object value as null or some known token for identification. A single object in a Transaction Cluster 201 can have multiple object values at different timestamps. Transaction Compactor compacts these multiple values of an object to a single value with the latest timestamp value as the winner, simplifying records and reducing cluster size. Transaction Compactor can work at the recording time of each transaction or at as periodically as service for better performance. The Transition Compactor compares and merges sorted string tables created by both types of memtables. The graph theory principles are used to analyze the final location and state (value) of the record. All the transactions are timestamped, and a directed graph is built to solve the problem of compacting (A->B, A->C, B->C) type problem. The final outcome is decided based on precise timestamps. Timestamps on each value or deletion are used to figure out which is the most recent value. The technique used for keeping sorted files and merging them is called the Log-Structured Merge (LSM) tree. It does not need reading entire SSTables into memory and requires mostly sequential disk reads. It is popularly used in Lucene search engine and Cassandra database. The solution uses very accurate NTP or PTP time sync to avoid any data corruption.

In the backup subsystem, transaction collector 209 is used to get rid of the old data that has been already saved by snapshots. All the recorded transactions by the traffic recorder 210 are set to expire after a specific time generally in multiple of snapshotting interval. The time after which a transaction will expire is called Garbage Collection (GC) grace value or TTL value. Transactions are also marked expired or deleted by Transaction Compactor during the cluster compaction. It compacts away old, GC/TTL expired transactions periodically at specialized triggers for better performance. In one embodiment, Transaction compactor and collector can be a single unit. The merged snapshot followed by precise transaction replay can recover the cluster at any desired point of time. The data is the transition cluster get deleted by the transaction collector 209 during the collection stage due to the expired TTL value, which is generally set a positive multiple of snapshotting internal of the data cluster 101. The concepts of ‘compactor’ come from graph theory and concept of ‘collection’ from merging Sorted String tables and their use for transaction compaction is completely novel.

The generated backup version or backup snapshot (full, incremental or deltas) are stored in the separate Backup Cluster 202. Cloud with cheap disk space like Glacier can act as a great alternative to the local Backup Cluster. The desired number of generated versions to be retained in the cloud or Backup Cluster. Just like Transaction Cluster 201, it is only required during a crash for Recovery. So, it can be economically designed Cluster or distributed Database solution as performance is not much concern.

In the backup subsystem, Snapshotting and Cloning Module 203 (SCM) is responsible for taking a snapshot of the medium and cloning the snapshotted version to a local or remote location for storage. Cloning module facilitates creating a clone of data storage based on the point-in-time version of data storage or the snapshotted version. Depending upon architecture, SCM can be used to clone both data and metadata information. For different types of storage mediums and filesystems, there are different functionalities of SCM. If the data storage medium is an Object Storage, Snapshotting module takes snapshots of the Object Storage data and metadata nodes, clones the snapshotted version and saves it in Backup Cluster 202.

The SCM takes the snapshot of both the data and metadata nodes. The Data Dereplicator 204 uses the snapshotted metadata information for removing the extra replicas effectively coordinating between Metadata Cluster 108 and Data Cluster 101. The data deduplicator 205 and data differentiator works for both data and metadata independently but in a similar manner. All the processed snapshots are saved in the backup Cluster.

During snapshotting, journaling, recovering, and replaying all the data and metadata nodes need to be preciously synchronized. All the nodes are synchronized with a local NTP server. The NTP stratum 2 clock servers have sub-millisecond accuracy and stay coordinated with its stratum 1 servers with less than 200 microseconds offset. Stratum 3 or below can have sub-millisecond accuracy and can be inaccurate enough to create a problem in distributed systems. For higher accuracy, Precision Time Protocol (PTP) is preferred over NTP. PTP protocol used to synchronize clocks throughout a computer network and distributed solutions. On a local area network, it achieves clock accuracy in the sub-microsecond range, making it suitable for measurement and control systems. Chrony, a popular alternative to ntpd, that comes shipped with Red Hat 7 distribution and is also available in the Ubuntu repositories. It supports synchronization with both PTP as well as NTP and is faster synchronizing, more stable and more accurate in ntpd.

All nodes in a cluster are periodically committed and each commit results in a new data version or snapshot. The snapshot can be a full backup snapshot, a complete rendering of the data. Or it can be an incremental backup snapshot, a rendering of difference between last full snapshot of the previous commit and current data. Alternately, it can delta backup snapshot, a rendering of difference between last full or incremental snapshot of the previous commit and current data.

The object storage filesystems that support Copy-On-Write (CoW) and allocate-on-flush like Btrfs and ZFS inherently support the snapshotting, versioning and cloning the snapshots. The Clone operation atomically creates a quick CoW snapshot of files and the cloned files are referred to as reflinks. By cloning, the Object Storage does not create a new link pointing to an existing inode. Instead, it creates a new inode that initially shares the same disk blocks with the original file. The actual data blocks are not duplicated. Due to the CoW, any further modifications to original files will not be visible in the cloned version of files. With kernel submodule, reflinks can be copies from the file-system that will duplicate the data and the Object Storage image can be formed. For incremental snapshot images, only the files modified in the current snapshot since the last full snapshot are copied to the new Object Storage called incremental disk. For delta snapshot images, only the files modified in the current snapshot since the last snapshot (full or incremental) are copied to the new Object Storage called delta disk.

The object storage filesystems that do NOT support Copy-On-Write (CoW), can be snapshotted and cloned with the help of volume manager like Logical Volume Manager (LVM) allows the creation of read-write snapshots. Taking the snapshot of the Object Storage involves temporarily halting input/output (I/O) to the filesystem using Object Storage specific freeze utility, having the volume manager perform the actual snapshot, and then resuming I/O to continue with normal operations. Volume Manager implements copy-on-write on entire storage devices by copying changed blocks, just before they are to be overwritten within “parent” volumes to other storage, thus preserving a self-consistent past image of the block device. The snapshot can then be copied to form the Object Storage image. For incremental and delta snapshot images, only the modified data blocks since the last full snapshot and since the last snapshot respectively are copied to the new Object Storage. If the volume manager does not support snapshot revisions, delta differencing can create incremental or delta disk. In another embodiment, there can be kernel module for snapshotting, especially for the Object Storage s which do not support snapshotting and volume manager.

In common object storage offerings, like OpenStack Swift, IBM General Parallel File System (GPFS) or Luster, there is a centralized dedicated metadata database 105 or metadata cluster 108 to host the file system index and the secondary or backup NameNode. The backup NameNode provides High Availability (HA) in case primary failover and can also generate snapshots of the NameNode memory structures. Due to immutable files in such file-systems, there are No updates, just create and delayed timely deletes. The information from the secondary NameNode memory structures can be used to recreate the single distributed filesystem image, before the next deleting or the collection cycle.

In some distributed systems, Snapshotting and Cloning 203 of a node takes time and disturbs the incoming traffic requests especially when Object Storage does not support snapshot or when file system payload is not immutable. When a single node goes out of service for a snapshot, the availability is not affected as requests are transferred to the alternate replicas. So, for such system, NTP/PTP synchronized distributed snapshotting is not possible and snapshots need to be taken node by node. Unsynchronized Distributed Snapshotting does not provide a globally distributed state, but it can be taken care by replaying some extra traffic from the point of time of the starting of the first node to snapshot and handling duplicate mutations like double write, update or delete. Alternately, there are distributed snapshot algorithms that can provide a consistent global state. The Chandy-Lamport algorithm is a popular distributed snapshotting algorithm for recording a consistent global state of an asynchronous distributed system without affecting the incoming traffic. It uses process markers and channels for communication between the snapshotting processes on each node. Nodes can communicate with binary communication protocols like Apache Thrift or Google Protocol Buffers (Protobuf) or Apache Avro. A consistent global state is one corresponding to a consistent cut. A consistent cut is left closed under the causal precedence relation i.e. if one event belongs to a cut, and all events happened before this event also belongs to the cut, then the cut is considered to be consistent.

In the backup subsystem, Data Dereplicator 204 is used to reduce the data replica count to 1. Every distributed storage replication module or the replicator that is responsible for maintaining a replica count equal to the Replication Factor for the cluster. When the replication factor is increased, it increases the number of replicas in load balancing manner and when the replication factor is decreased, it gets rids of the extra replicas effectively acting as de-replicate. Due to the high replication factor, there is a lot of data redundancy in the file system snapshots on each node on each node taken by the Snapshotting and Cloning Module 203. The cloned file system images can be mounted on the respective nodes in a separate location and the Data Dereplicator 204 module can remove the data redundancy when running with replication factor configured as 1. A snapshot of metadata is required at the same time as the node snapshot. If metadata is in a separate Metadata Cluster 108, Snapshotting, and cloning module 203 (SCM) can be used to snapshot and clone metadata nodes just like data nodes. The metadata snapshot thus obtained can be used by the Data dereplicator 204 module to remove the extra replica or copies. If the metadata is managed in a Metadata Database 105, a database specific snapshotting tool is used. The Metadata Database 105 memory structure can be used by Data Dereplicator 204 to remove the extra replicas of the data.

In the backup subsystem, the data deduplicator 205 is used to perform post-process deduplication after Data Dereplication. Data Deduplication is a technique is used to improve storage utilization and can also be applied to network data transfers to reduce the number of bytes that must be sent. In the deduplication process, unique chunks of data, or byte patterns, are identified (called fingerprints) and stored during a process of analysis. As the analysis continues, other chunks are compared to the stored copy and whenever a match occurs, the redundant chunk is replaced with a small reference that points to the stored chunk. After data dereplication 204, a client-side post-process deduplication is used. During backup, the Data Cluster 101 or Metadata Cluster 108 is the source and Backup Cluster 202 is the target. In post-process deduplication, the new data generated by SCM during cloning is first stored on the storage device and then a process at a later time will analyze the data looking for duplication to ensure high performance. In storage sensitive systems when storage capacity is limited, in-line deduplication can also be used for trading off performance. Deduplication occurring close to the source or the generated cloned data is called source deduplication or client-side deduplication. It is very efficient in saving network bandwidth especially during full snapshot clones and when the Backup Cluster 202 is in the cloud. In case of recovery, source and targets are reversed i.e. Backup Cluster 202 is the source and the data or Metadata Cluster 108 is target and rest of the architecture is the same or similar.

Dedupeio's dedupe is an accurate, popular, and scalable fuzzy matching, record deduplication and entity-resolution for intelligent chunking and fingerprinting.

In the backup subsystem, data differentiator 206 is an optional backup subsystem module to solve the same problem as data deduplication but rather that replying data chunks, it relies on logical file names or hard-link names. Data differentiator is especially important when the data system is a payload on Host File System. It facilitates faster incremental or delta snapshots. In Recovery subsystem, Data Differentiation Rebuilder 306 works by copying the file to the required replicas and removing the extra hard links that were added by data differentiator 206.

### Backup Process

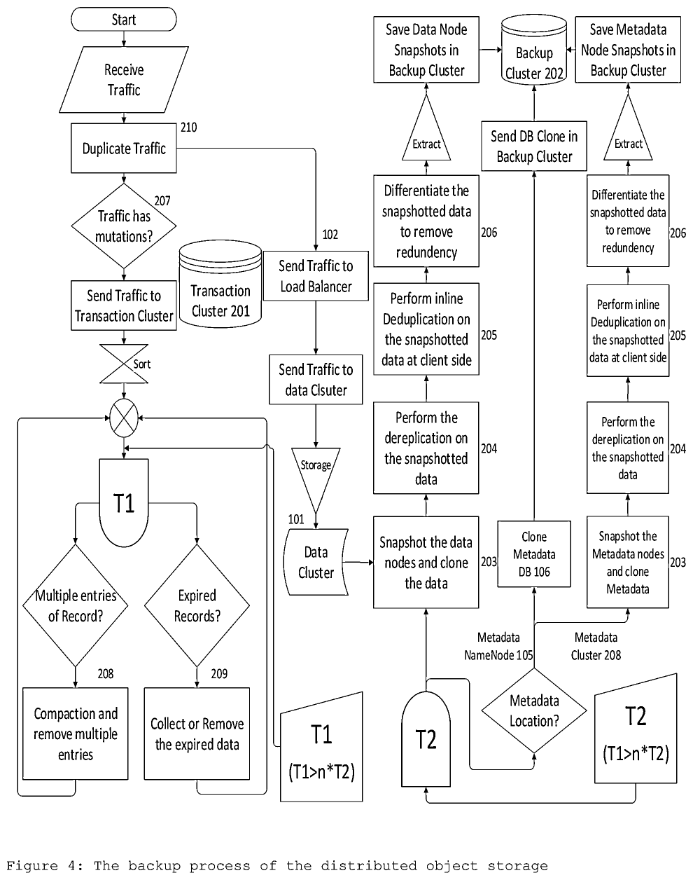

The backup process consists of 2 parallel processes 1. Periodically snapshotting the Data Cluster 101 and NameSpace Metadata Cluster 108 or using secondary NameNode 106, a clone of NameNode 105 and copying optimized data to Backup Cluster 202 for course recovery. 2.: Live Traffic recording of mutation traffic as Transactions in Transaction Cluster 201 for accurate and precise recovery. The snapshotting period T2 is period at which Data Cluster 101 and Grace Period T1 is time-to-live (TTL) value set in the Transaction Cluster 201 such that T1>T2 for recovery to work precisely and preferably T1>n*T2 to enable precise recovery in last n snapshotting cycles. FIG. 4 describes the process flow of the Backup Process of Distributed Object Storage.

All the nodes in the Data Cluster 101 and Metadata Cluster 108 or Metadata Database 105 are in sync by the Synchronization Service 103 and are periodically committed at snapshotting interval T2 by the Snapshotting and Cloning Module 203 (SCM) implemented specifically for the cluster. Each commit results in a Full backup, Incremental backup or Delta backup snapshots.

The Snapshot or cloned filesystem backup image can be mounted on the respective Data Nodes or Metadata NameNode(s) 105 in a separate location and the Data Dereplicator 204 module is run on the images with block replication factor configured as 1 to remove the data redundancy. The Data Differentiator 206 is used for payload on Host File System as it facilitates faster incremental or delta snapshots. After Data Dereplication, a client-side post-process deduplication is used. The Dereplicated backup images on the respective nodes are analyzed at a later time by the Data deduplicator 205 for finding duplication clunks by comparing with the fingerprint from Backup Cluster 202. Then only the changed clunks are sent to the Backup Cluster 202 to save bandwidth and storage. In some distributed Object Storage, snapshotting and cloning of a node takes time and disturbs the incoming traffic requests especially when filesystem does not support snapshot or when filesystem payload is not immutable, Unsynchronized distributed Snapshotting is preferred over the Synchronized Distributed Snapshotting.

Like HDFS, if

Snapshotting and Cloning Module 203 (SCM) implemented specifically for the cluster.

All the incoming traffic requests are copied and recorded with a timestamp and mutated object reference by the traffic recorder 210 that is integrated inside the Proxy Server 104. The one copy traffic data is sent to the Load Balance 102 as in the original architecture. From the other copy of traffic data, mutation transactions (write, modify, delete) are filtered by Transaction Filter 207 and are sent to the Transaction Cluster 201 by the traffic recorder 210.

Internal transactions from the various Internal Services 106 are also journaled and sent to Transaction Cluster 201 periodically. All the recorded Transactions are in a defined format or schema with essential fields like mutated object reference or id, the timestamp, and mutated object value and some additional metadata information. When an object is deleted, the corresponding transaction is marked deleted. A single object in Transaction Cluster 201 can have multiple object values at different timestamps. Transaction Compactor 208 compacts these multiple values of an object to a single value with the latest timestamp value as the winner, simplifying records and reducing cluster size. All the recorded transactions by traffic recorder 210 are set to expire after a specific time generally in multiple of snapshotting interval, called GC grace value or TTL value. Transactions are also marked expired by Transaction Compactor 208 during the Transaction compaction. The transaction collector 209 compacts away old, GC/TTL expired transactions periodically at specialized triggers for better performance.

### Recovery Architecture

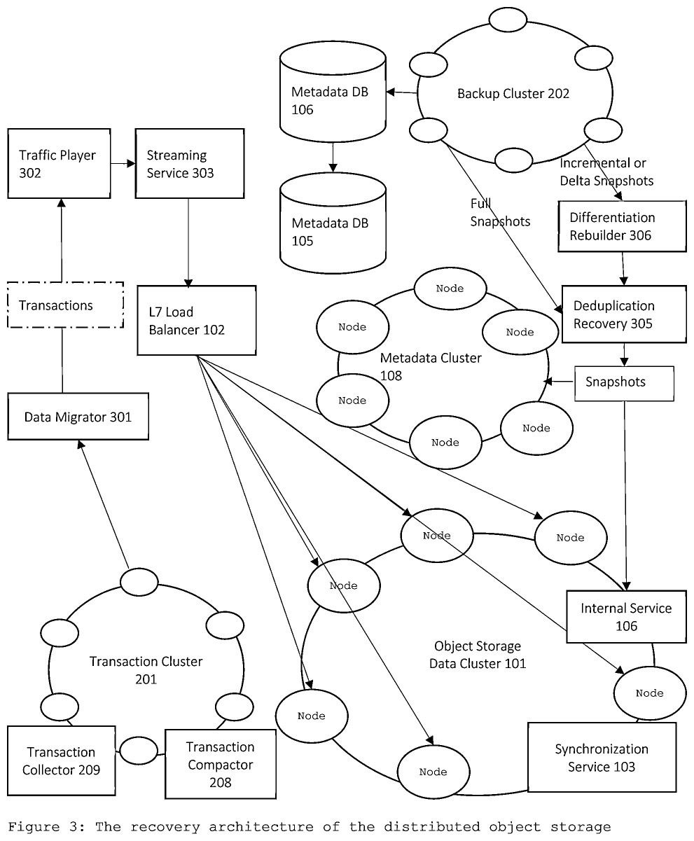

The Recovery subsystem consists of all 3 Clusters, Data Cluster 101, Transaction Cluster 201, and the Backup Cluster 202. It has components like Data Migrator 301, Traffic Player 302 and Streaming Service 303, that are only present on the recovery path. Other components like Deduplication Recovery 305 and Differentiation Rebuilder 306 in the recovery subsystem, are counter components of the data deduplication 205 and the data differentiator 206 in the backup subsystem respectively and are already discussed in the backup architecture. FIG. 3 describes the recovery architecture in the distributed object storage.

In the Recovery subsystem, the data migrator 301 is used to stream the Transaction data back in the Data Cluster 101. There are plenty of data migration tools and ETL solutions available depending upon the Data Cluster 101 or database product used in Transaction Cluster 201 developed by open source community and tried-party companies like Informatica, Microsoft. Apache Flume is a distributed, reliable, and available service for efficiently collecting, aggregating, and moving large amounts of data. Flume is a great tool to migrate data from RPC (Avro and Thrift native), sequential log files, JMS, Kafka, and Netcat/TCP sources. Apache Sqoop is a connectivity tool for migrating data from data stores such as relational databases and data warehouses into Hadoop. It allows moving data from any kind of relational database system that has JDBC connectivity like Teradata, Oracle, MySQL Server, Postgres or any other JDBC database. Sqoop can also import data from NoSQL databases like MongoDB or Cassandra. Logstash is a server-side data processing pipeline that ingests data from a multitude of sources simultaneously, transforms it, and then sends it to the required destination. The collection is accomplished via configurable input plugins including raw socket/packet communication, file tailing, and several message bus clients and has over 200 plugins supporting multiple sources. Fluentd is another cross-platform open source data collection software project originally developed at Treasure Data. It supports a long list of Data Sources.

In the Recovery subsystem, Transaction Player 302 is used to replay the stored transactions as mutation traffic, and the Streaming Service 303 is used to stream the traffic at the desired rate. After the snapshot recovery is complete, transaction Player migrates the data from the Transaction Cluster 201, transform it to the original request format and then streams back to the Data Cluster 101 in the order of the transaction timestamp. There are multiple streaming solutions available to the stream the data coming from Transaction Cluster 201 back to the Data Cluster 101. In some embodiments, data migrator 301, transaction player, and streaming service can be one or more components. For example, Kafka can act as both data migrator 301 and streaming service. Apache Kafka is a popular stream-processing software platform that provides a unified, high-throughput, low-latency platform for handling real-time data feeds. LinkedIn initially developed it. Its storage layer is a “massively scalable pub/sub message queue architected as a distributed transaction log. In Kafka, the streaming parallelism is equal to the number of partitions for a topic. The traffic can be divided into topics using the object's meta information, where two topics are logically independent. In each topic, traffic is divided into multiple partitions where streaming is in parallel between partitions and in order of the timestamp in a single partition. Kafka only provides total ordered streaming of messages within a partition of the topic and does not guaranty in order delivery on a topic. Both topics and partition provide parallelism for the replay. Flink provides another high-throughput, low-latency streaming engine as well as support for event-time processing and state management. Flink applications are fault-tolerant in the event of machine failure and support exactly-once semantics. Flink supports both event time and out-of-order processing in the DataStream API. Apache Apex is a YARN-native platform that unifies stream and batch processing. It processes big data-in-motion in a way that is scalable, performant, fault-tolerant, stateful, secure, distributed, and easily operable. It supports input and output operations to sources and sinks such as HDFS, S3, NFS, FTP, Kafka, ActiveMQ, RabbitMQ, JMS, Cassandra, MongoDB, Redis, HBase, CouchDB, generic JDBC, and other database connectors. Apache Storm is a distributed stream processing computation framework developed by Twitter.

SCM uses information from snapshots of the secondary NameNode 106 to recreate the single distributed filesystem image, before the next deleting or the collection cycle. The Data Dereplicator 204 coordinates with SCM and uses the snapshots of the secondary NameNode 106 for removing the extra replicas. The Data deduplicator 205 is used for bandwidth and storage optimization if the previous backup was taken. The Data Differentiator is used to compare NameNode 105 changes between incremental and delta snapshot backups.

### Recovery Process

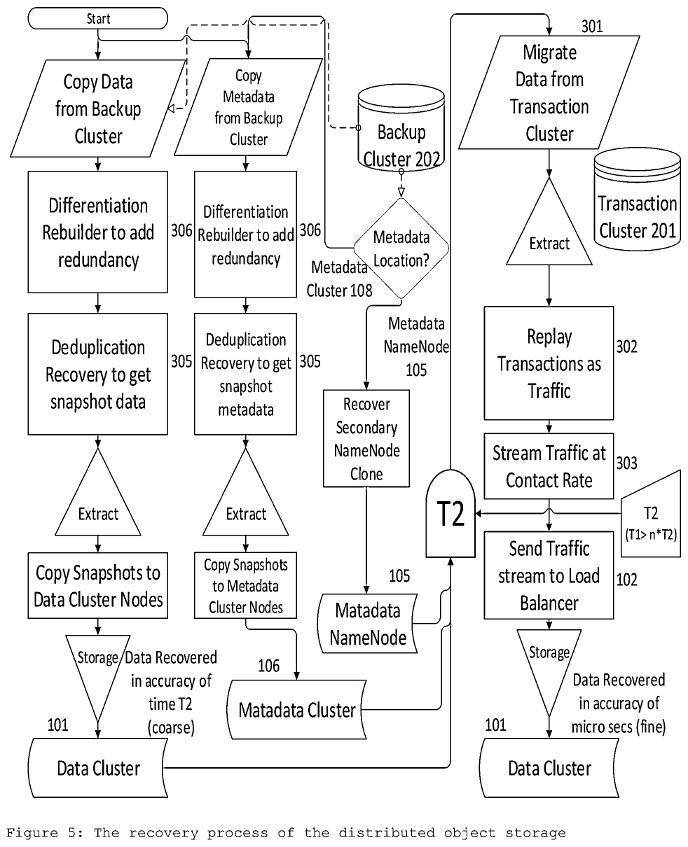

After a crash, the new traffic cannot be served until the Data Cluster 101 is reverted back to the desired point-in-time and cluster is put in the maintenance mode and traffic is stopped. For recovery process consists of two parts 1. Finding and restoring or recovering the cluster to the nearest past snapshot before the desired point-in-time. 2 Redoing or Replaying all the transactions from the Transaction Cluster 201 after the snapshot to the selected point-in-time. FIG. 5 describes the process flow of the Recovery Process of Distributed Object Storage.

Once the desired point-in-time is selected to recover to, the nearest past snapshot point is identified in the Backup Cluster. If it is a full backup, it can be directly restored. In case of incremental backup, it is combined with last full backup to create a current full backup image. In case of delta backup, the snapshot image is combined with all delta backup images till the last full backup image and the last full backup image to create a current full backup image. The restore system is required to have the same number of Data Nodes or Metadata Nodes as the number of nodes when the snapshot was taken. In case of recovery, source and targets are reversed i.e. Backup Cluster 202 is the source and the Data Cluster 101 and NameSpace metadata cluster 108 is target and rest of the architecture is the same or similar.

The differentiation rebuilder 306 is used to restore the original number of the file that was reduced by Data Differentiator 206 after data is copied to data nodes In Data Cluster 101. After that, Data deduplicator Recovery 305 performs the server side (the Data Cluster 101 side) deduplication restore to remove the deduplication done by data deduplicator 205 during the backup and save network bandwidth while data is moved back to the Data Cluster 101. After Data Cluster is successfully recovered, the timed snapshot of the secondary NameNode 106 is set as the primary NameNode 105, to recreate point-in-time NameSpace Metadata. If in the distributed cluster filesystem, filesystem NameSpace information is stored separate Metadata cluster 108, the Metadata NameNodes are recovered in the same as the Data Nodes. After both Data Cluster and metadata Cluster are recovered, the core Object Storage service and other internal services are started again.

The replicator service on the data nodes in the data cluster 101 will increase the replica count from 1 to the block replication factor for the cluster as during backup process block replication factor was reduced to 1 by the data dereplicator 204. There is a small added delay of time T3 (T3<T2), to make sure Data Cluster replicas are restored and the next recovery steps can we started. After this step, the data cluster 101 is restored back accuracy in time precision T2 from the desired point-in-time of restore and so the raw or basic recovery is complete.

The accurate recovery of the Data Cluster is possible only in time duration T1 which is chosen to greater than a multiple (n) of the snapshotting period (time T2). So, we can do accurately in last n snapshot cycles and past that we are capable of only doing coarse recovery. After the data and metadata snapshot recovery is complete (after wait time T3<T2), Data Migrator 301 is used to selectively migration data between recovered snapshot time and desired point-in-time for recovery from the Transaction Cluster 201. Data Migrator 301 is implemented depending upon the type of Data Cluster 101 or database product used in transaction cluster 201. All the transactions in the Transaction Cluster 201 are optimized to remove any duplicate and unwanted paths for object values and the expired values past time T1 (T1>n*T2). The migrated data is feed to the Transaction Player 302 which transforms the Transactions back to the original Traffic (request) format. Streaming Module 303 is Message Oriented Middleware (MOM) service to reliably transfer the requests to the Load Balancer 102. Load Balancer 102 then sends the traffic to the data nodes of the Data Cluster 101 in a load balancing way completing the ETL loop. The traffic can be divided into topics by the Streaming Module 303 using the object's meta information, where two topics are logically independent. In each topic, traffic is divided into multiple partitions where streaming is in parallel between partitions and in order of the transaction timestamp in a single partition. Data Migrator 301 selects and loads the transaction from Transaction Cluster 201, Traffic Player Transform it back to the original request form and Streaming Service streams it back to the data Cluster. Since the transactions were optimized, all the internal transactions are already played with just streaming, saving a lot of computing resources and reducing the recovery time significantly.

We claim:

1. The architecture of the backup solution for distributed on-premise or cloud object storages following common object storage architecture pattern and consisting of a distributed file system and a metadata cluster or database. The backup solution architecture uses the following components and capabilities
1.1. having centralized or distributed transaction journaling system for journaling of internal cluster services and sending it to the transaction cluster or transaction database; with the transaction compactor and the transaction collection components for the simplification of the transactions that allow the solution to have very low Recovery Time;
1.2. combining external transactions from various applications with the transactions generated from the journaling the internal services of the object storage to remove the need for duplicated work to be done after recovery;
1.3. having components like the traffic recorder and the transaction filter in the data path between data cluster and transaction cluster or transition database and where traffic recorder component duplicates incoming traffic, and the transaction filter filters out the mutations REST, RPC or HTTP traffic and transform it to the transaction format to be stored in a decoupled transaction cluster or transaction database and having component data dereplicator between data cluster and backup cluster or on either cluster that reduces the number of replicas sent to or stored in the backup cluster;

2. The architecture of a recovery system for distributed object storages following common object storage architecture pattern and with the component transaction player that transforms the transaction back to request to recover accurately in a specified point in time and a streaming service component to stream the traffic at the desired rate.
